(19) United States
(12) Patent Application Publication
(10) Pub. No.: US 2013/0238973 A1
(43) Pub. Date: Sep. 12, 2013

(54) APPLICATION OF A TOUCH BASED INTERFACE WITH A CUBE STRUCTURE FOR A MOBILE DEVICE

(71) Applicant: Ming Han Chang, Taipei (TW)

(72) Inventor: Ming Han Chang, Taipei (TW)

(21) Appl. No.: 13/417,243

(22) Filed: Mar. 10, 2012

(51) Int. Cl. G06F 3/048; G06F 17/00; G06F 3/041

(52) U.S. Cl. 715/234; 715/849; 715/828

(57) ABSTRACT

A computer system and method to browse and to move files of a first folder in a horizontal reviewing mode, files of a second folder a first vertical reviewing mode and files of a third folder in a second vertical reviewing mode in the touch display of a portable device is described. The method provides a three dimensional cube rotation scene including a portion of one of second files during the transition in said touch screen. The computer system has a folder selection mode during the switching from the horizontal reviewing mode to the first vertical reviewing mode. The computer system further has a category reviewing mode which enables a user to review folders in each category, wherein each category is presented in different layers of a category tree.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The application relates to an interface to review, browse and manage files on a mobile device. More particularly, the invention relates to an interface applying gestures together with a cube structure on a mobile device.

In the early development of mobile device such as Palm PDA, a stylus is a necessary input device. The operation of the touch screen of the early mobile device requires a stylus—a narrow elongated pen to accurately navigate the menu or to perform functions. Thereafter an interface for a touch screen mobile device is therefore designed based on such stylus usage experience. The old usage experience encountering the new input technology does not explore all benefits of such new technology. Therefore a new interface design is needed.

In new mobile device such as iPhone, a circuitry to sense a finger's touches is widely employed. One of most important finger action when compared with the stylus operation is finger swiping. One common application of swiping gesture is to change pages in the home screen. Another common application is to review photos. Users swipe horizontally to review photos sequentially in the album.

In this invention, gestures for touch based interface are disclosed to improve files, data, and pages reviewing ability and to facilitate files, data and pages management including but not limited to files, data and pages classification and files, data and pages storage arrangement.

### BRIEF SUMMARY OF THE INVENTION

In accordance with one embodiment, a computer system comprises a touch display; one or more processors; memory; and a program, wherein the program is stored in the memory and configured to be executed by the one or more processors, the program including instructions for performing an interface on the touch display to browse and to move files of a first folder in a horizontal reviewing mode, files of a second folder a first vertical reviewing mode and files of a third folder in a second vertical reviewing mode.

### BRIEF DESCRIPTION OF THE DRAWING

FIG. 1 shows a single row photo browsing (Prior Art).

FIG. 2 shows a multi rows photo browsing (Prior Art).

FIG. 3a shows a reviewing system employing a cube structure

FIG. 3b shows the visible area 12 in the horizontal reviewing mode

FIG. 4a shows a rotation in a 3D illustration to reveal the photo 102 in the first vertical reviewing mode

FIG. 4b shows a predefined rotation gesture

FIG. 4b-1 shows a level of finger movement in a touch screen

FIG. 4c shows the photo 102 in the first vertical reviewing mode

FIG. 4d shows a reviewing system employing a cube structure

FIG. 4e shows a pull out menu 46

FIG. 5 shows a queue in the first vertical reviewing mode

FIG. 6 shows a relocation of one photo

FIG. 7 shows a relocation of one photo

FIG. 8 shows a page-flip to enter a content reviewing mode

FIG. 9 shows a page-flip to enter a content reviewing mode

FIG. 10 shows a page-flip to enter a content reviewing mode

FIG. 11a shows in one embodiment a phone in the horizontal reviewing mode

FIG. 11b shows in one embodiment a phone physically rotating

FIG. 11c shows in one embodiment a phone entering the first vertical reviewing mode

FIG. 11d shows in one embodiment a phone physically rotating without changing the mode

FIG. 11e shows in one embodiment after applying a horizontal swipe in the touch screen, a phone is changed to the horizontal reviewing mode and

FIG. 11f shows in one embodiment after rotating as FIG. 11b does, a phone entering the first vertical reviewing mode

FIG. 12 conceptually shows different mode areas

FIG. 13 conceptually shows the relationship with a circle gesture and folders in a tree structured category

### DETAILED DESCRIPTION OF THE INVENTION

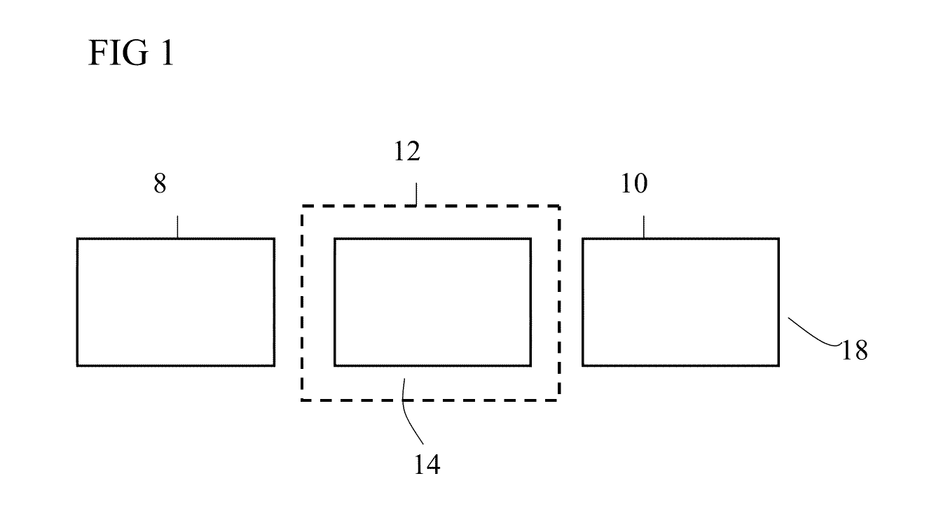

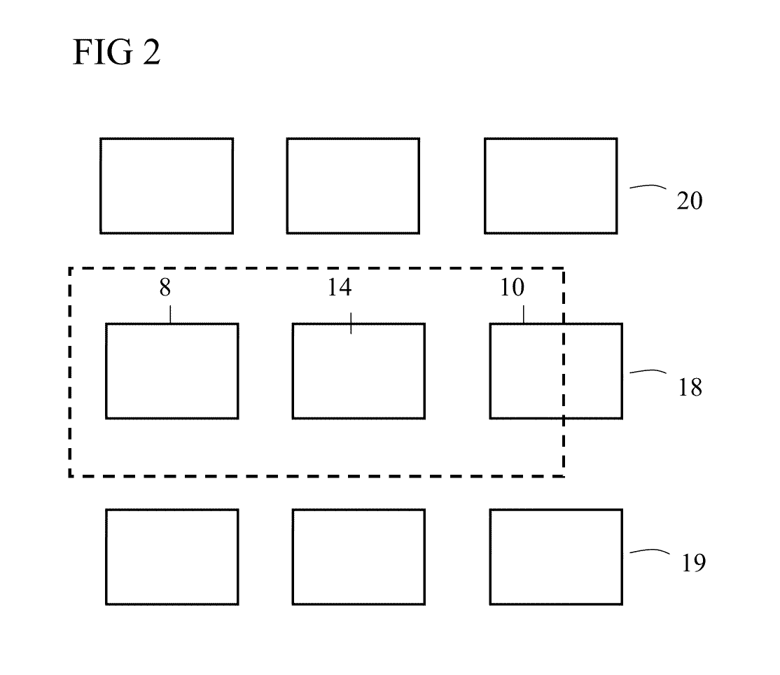

A photo browsing application is shown in FIG. 1. User reviews one photo in a queue 18 in the visible area 12 which is indicated by the dash-lined rectangular shown in FIG. 1. Other photo 8 and photo 10 are horizontally queued, therefore current visible area 12 only shows photo 14. It is possible to show more than one photo in the visible area 12 such as an example shown in FIG. 2. There are three photos—photo 8, photo 14 and a portion of photo 10 is shown. User applies horizontal swipe to view different photos in the queue. More advanced interface may have other queues 19 and 20 in different rows. An example in FIG. 2 shows that photos taken in different dates are listed in different rows. Therefore vertically swipe enabling a showing of a queue 20 or a queue 19 in the visible area 12.

Another common application of swipe gesture is to review or to select application icons in the home screen (Spring board). Usually users could add many applications in the home screen similar to what is shown in FIG. 2. Application icons may exist in different pages.

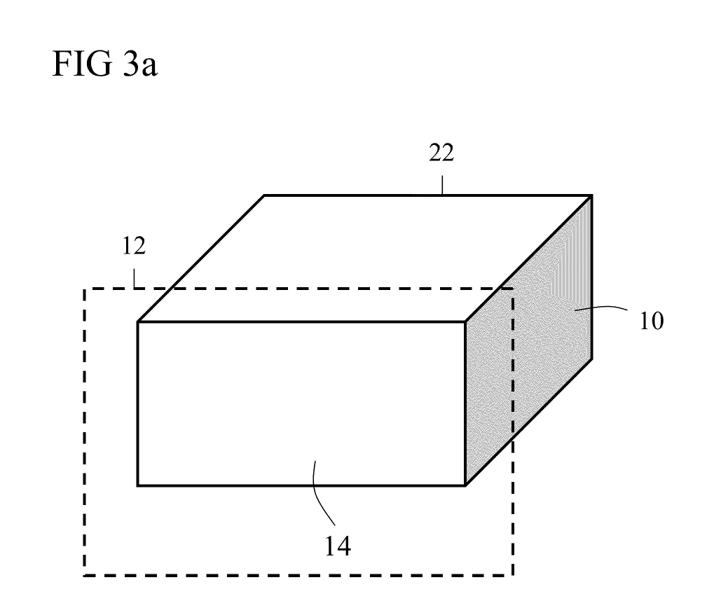

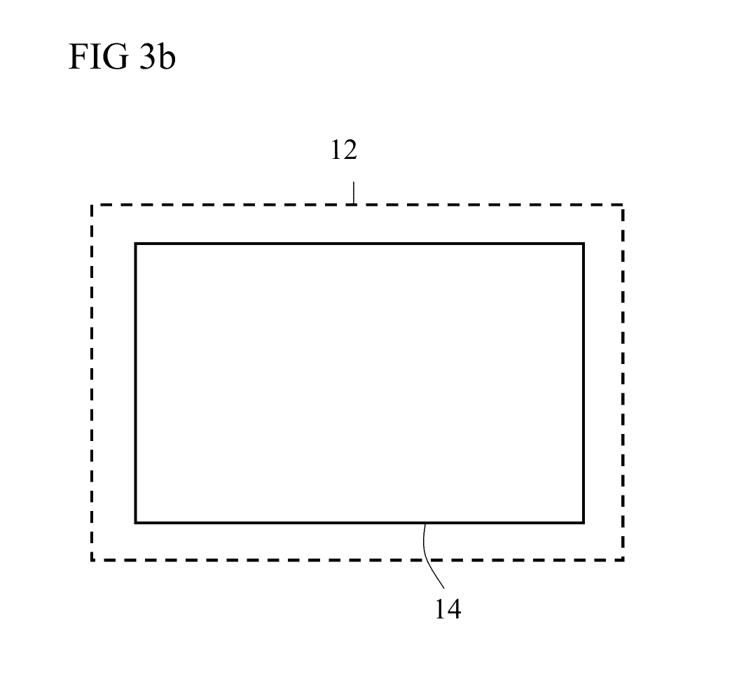

FIG. 3a shows a reviewing system employed a cube structure. The 3 dimensional cube 22 is not necessarily shown in the visible area 12 while in one of reviewing modes. The cube 22 in FIG. 3a shows a data structure concept. Same as in the queue 18, photo 10 is next to photo 14 in the right side. As shown in the FIG. 3b the visible area 12 while employing the cube structure in a horizontal reviewing mode, it shows one photo 14 in the visible area 12.

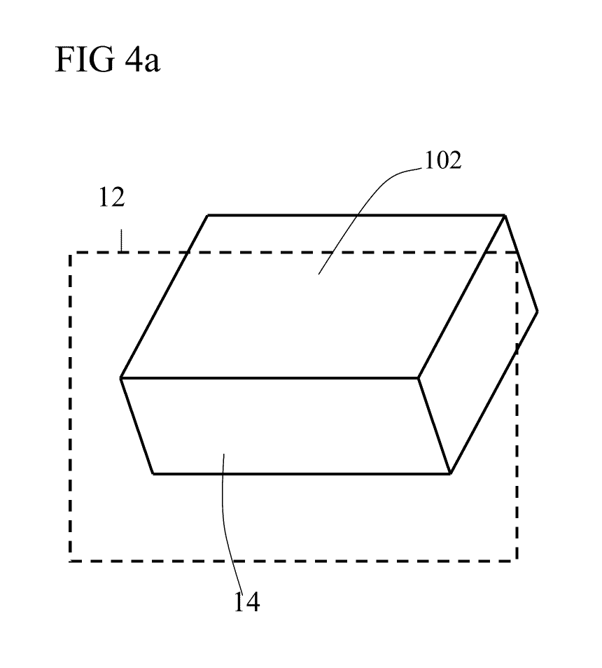

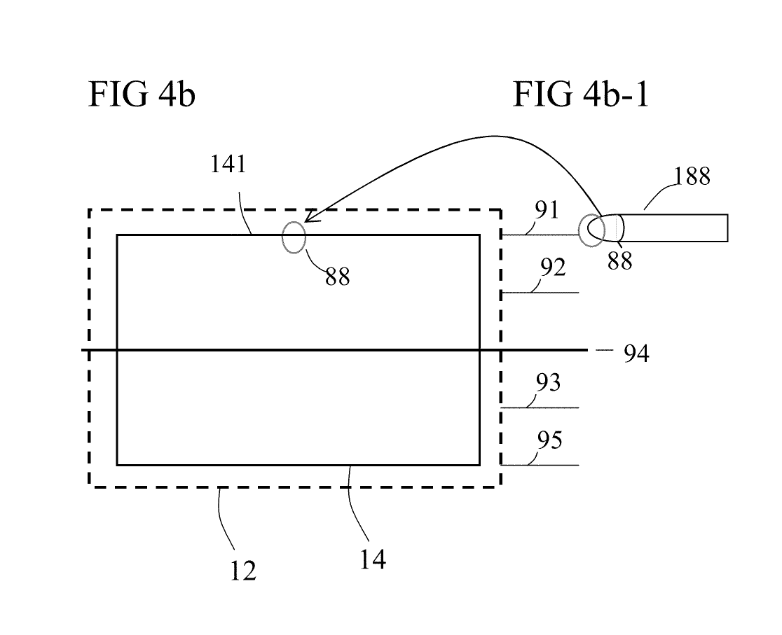

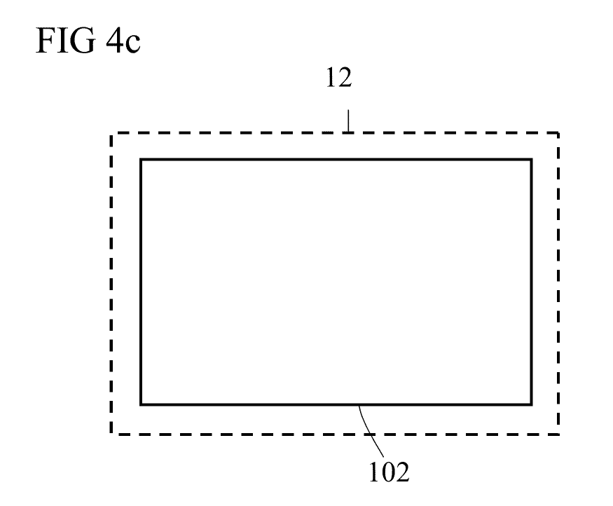

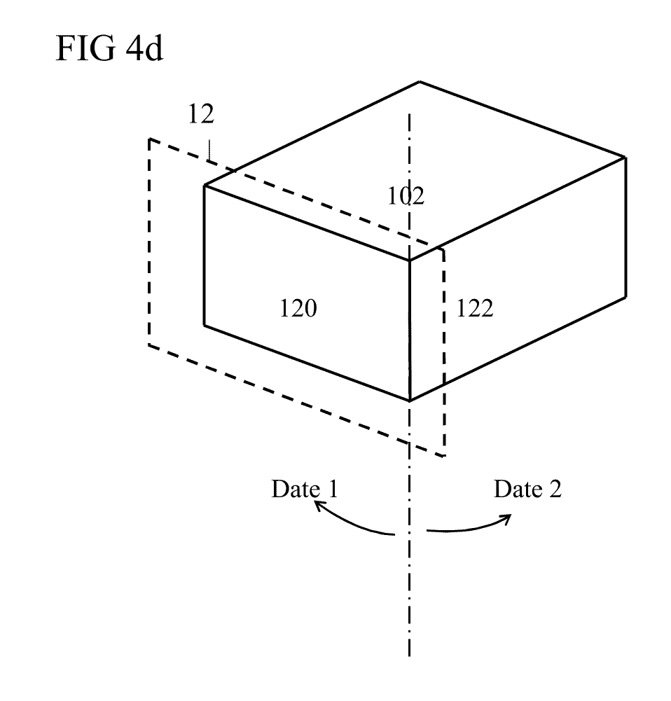

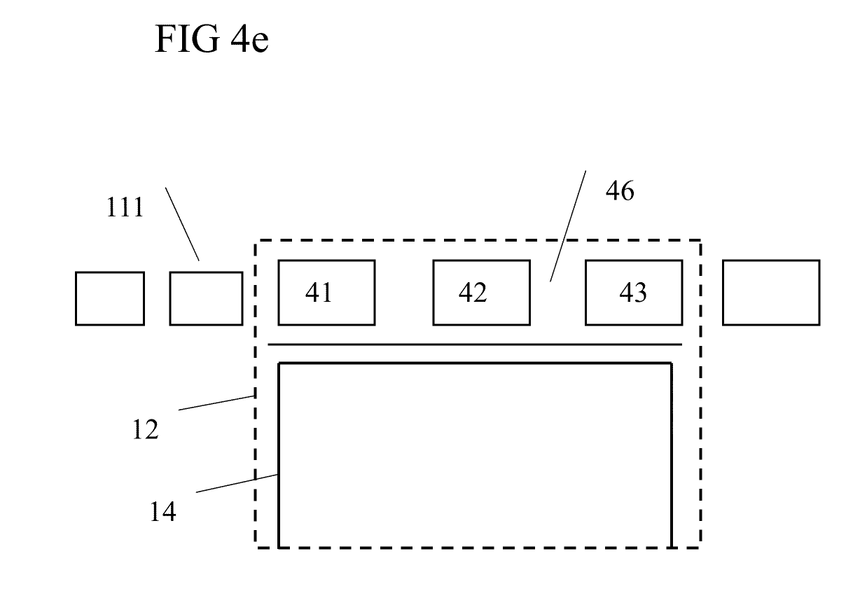

When user tries to rotate the cube 22 in FIG. 4a to show a photo 102 in the first vertical reviewing mode, user should perform a predefined rotation gesture which is described in FIG. 4b and FIG. 4b-1. In FIG. 4b and FIG. 4b-1, user contacts touch screen with a finger 188 on the upper edge 141 (to initialized the gesture) of photo 14 or in another embodiment, on the upper edge of the visible area 12, or between these two, continuously move from the point of contact 88 downward to rotate the cube downward as conceptually shown in FIG. 4a. The process contains several steps as described in FIG. 4b-1. To describe in more detail, FIG. 4b-1 shows the different movement levels during the rotation process. However the actual contact point is still inside the visible area 12 for example around area 88. In FIG. 4b-1, the beginning stage 91 is triggered when user touches the point of contact 88 and continuously moves downward. In one embodiment, when movement is a little over the stage 92 or stage 94, the photo 102 will be fully shown as in FIG. 4c. However it will bounce back if said movement is little such as not reach stage 92. In one embodiment, the areas to trigger the rotation operation are not the same depths across upper edge 141. It may be curved with a greater depth around center area 88. In another embodiment, while user has acknowledged the cube structure, smoothly swipe down from central of other areas of photo 14 could initiate the rotation.

The normal vertical swipe gesture as used in FIG. 2 will not trigger a rotation as described above. Except to rotation down or up, in one embodiment, user could rotate right or left. When user performs normal horizontal swipe continuously to the left in the horizontal reviewing mode, it stops at a photo 120 and reaches the first left bound in FIG. 4d. In the photo 120, user needs to perform a rotation gesture to review photo 122 which is date's photo. In one embodiment, similar to the up-down rotation, a pull out menu will show up during the transition of rotation. The folders in the pull out menu could be folders for dates. The folders may include a blank folder or a jump-to tab to switch folders for dates to folders for months.

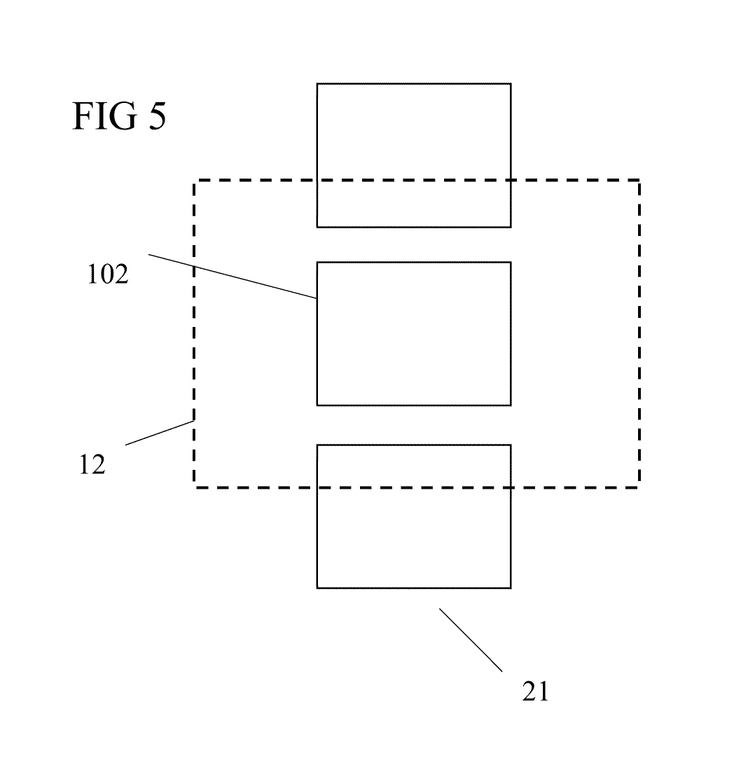

In FIG. 4b-1 when user reaches the stage 92 or before reaches the stage 92, it shows several folders in a pull out menu 46 as shown in FIG. 4e. Those are my favorite folder 41, printing folder 42 and social network sharing folder 43. Also a pull out menu would provide one blank folder to create new folder. In this embodiment, when user contacts the touch screen with a finger 188 on an edge, move from the point of contact 88 downward continuously, the pull out menu 46 is gradually pulled out and three folders as shown in FIG. 4e are fully revealed in certain stage level. At that stage, user could swipe horizontally in the pull out menu 46 to select a folder, i.e. making that folder to be center of the pull out menu 46. No mater whether user selects the folder or not, while continuously moving down further, a first photo of the folder in the middle of the pull out menu 46 is revealed in the first vertical reviewing mode. Therefore in FIG. 4e, if a user does not change the order of folder of the pull out menu 46, after competition of rotation gesture, user enters the group of photos for printing. During the transition while the pull out menu 46 is gradually revealed, the first photo of a first vertical reviewing mode is gradually shown up with a scene of cube rotation as mentioned in FIG. 4a or FIG. 4d. The scene will be a showing of cube edge to divide two photos; one belonged to the horizontal reviewing mode and the other belonged to vertical one. User at least sees a portion of the other photo during the transition or during the folder selection. The above could apply to rotate up, left and right gesture. In one embodiment, the pull out menu in the lower edge may include trash folder or actions tabs such as send, edit or share. For example, in the case of photo, one action may be a color enhancement function. User selects the action in the pull out menu in the lower edge and applies that action. While in the first vertical reviewing mode, user could swipe vertically to view other photos in the queue 21 of such group as in FIG. 5. In such mode, applying a normal horizontal swipe will return to horizontal reviewing mode. Therefore by rotation downward and upward in the horizontal reviewing mode, it is changed to vertical reviewing modes and by normal horizontal swipe in the vertical reviewing mode, it is returned to horizontal reviewing mode. The action tab may further include a time domain mode, where there is a showing of photos or webpages arranged by time in the horizontal reviewing mode.

One application could be on-line or off-line webpage reviewing. Horizontal reviewing mode is the history of web reviewing and first vertical reviewing mode is my favorite webpages. In this case the folders in the pull out menu 46, in one embodiment, are folders of my favorite pages as we usually classify folders in our traditional web browser. Other types of files such as music records or video clips could also be reviewed and classified.

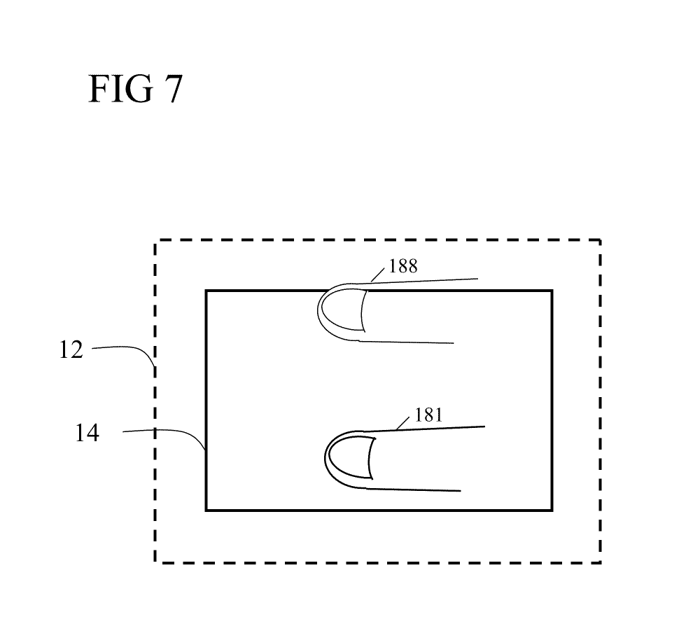

FIG. 7 shows how to move one photo. A touch screen with multi-touch function support is required. Reallocation of one photo in the same reviewing mode is just an ordering change in the queue. Reallocation of one photo from a reviewing mode to the other is a file or documentation classification or labeling or tagging. Taking FIG. 7 as an example, finger 181 presses the photo 14 and hold firmly as if finger attaches the photo 14. While finger 181 still attaches that photo 14, another finger 188 performs swipe gesture (to change the order in the same reviewing mode) or performs the pre-described rotation gesture to rotate the cube. (to move in different reviewing mode) If the finger 188 breaks the contact on the touch screen right after the rotation is completed, photo drops in the queue of the different reviewing mode. Again before fully enter other reviewing mode, it is possible to select folder in the pull out menu. Applied similar logic, to move one photo from a vertical reviewing mode to horizontal reviewing mode, user attaches one photo first then the other finger swipes horizontally to return back the horizontal reviewing mode and put such photo in the horizontal reviewing mode.

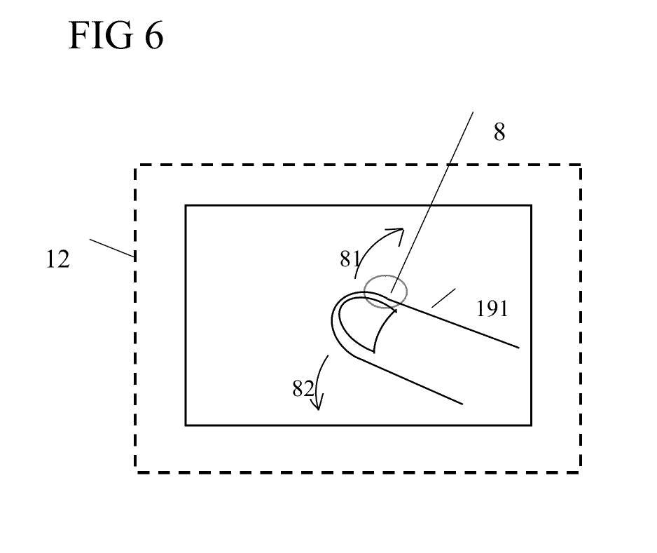

It is possible to perform such reallocation function by one finger. As shown in FIG. 6, user pressed photo 14 near the center 8 of photo 14 for a predefined time, then quickly flicks up or down. In one embodiment, it is preferable to use thumb 191 to flick and its tacks would like the track 81 or track 82 shown in FIG. 6. The photo 14 is relocated to the current folder in the vertical reviewing mode. Again the current folder is the center folder of the pull out menu 46.

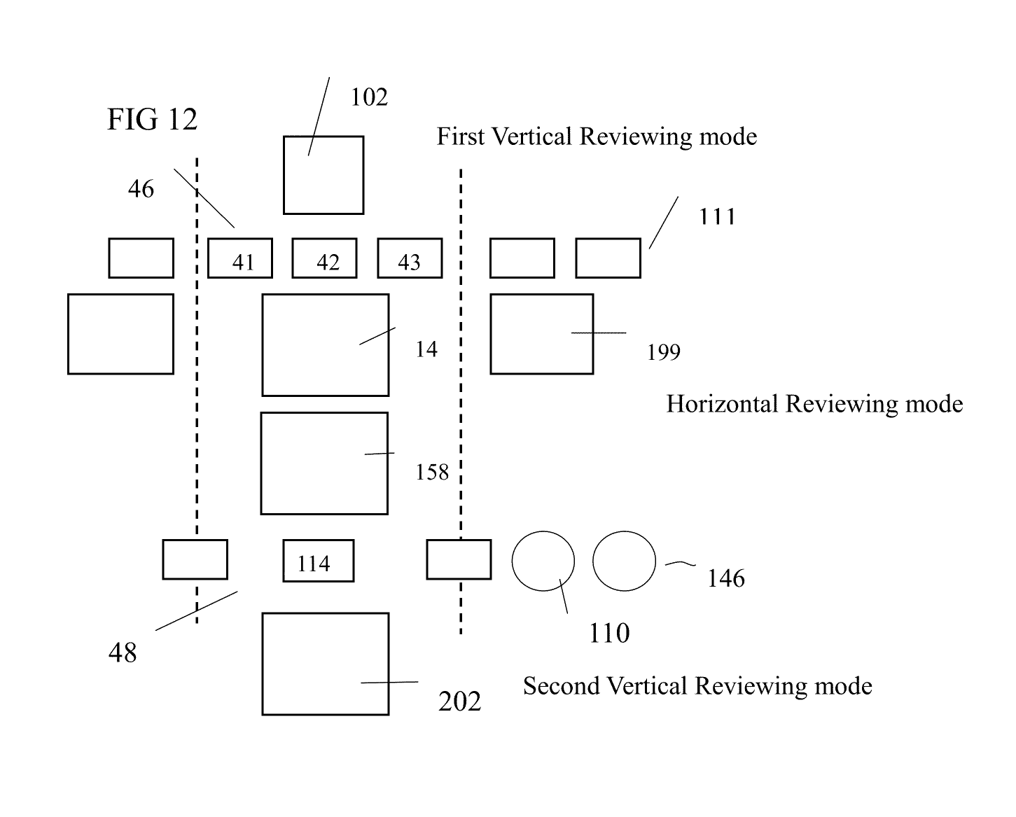

In the application of webpages reviewing, it is normal to have longer content other than one page format. A scroll down navigation is needed for original web reviewing. For example a webpage shown in FIG. 12 that contains a two-page long content. User could scroll down to see page 158 and meet the lower bound similar to the situation happened in photo 120 in FIG. 4d. In one embodiment, only a representative page represents a webpage in the vertical reviewing mode and horizontal reviewing mode. To review the content, a tap or double tap on the said page is used to enter a content reviewing mode. Such tap or double tap is analogue to flip over a post card. The first face of the post card is photo and tap or double tap is to turn over to the backside of the post card. Usually the backside of a post card shows more words or associated information.

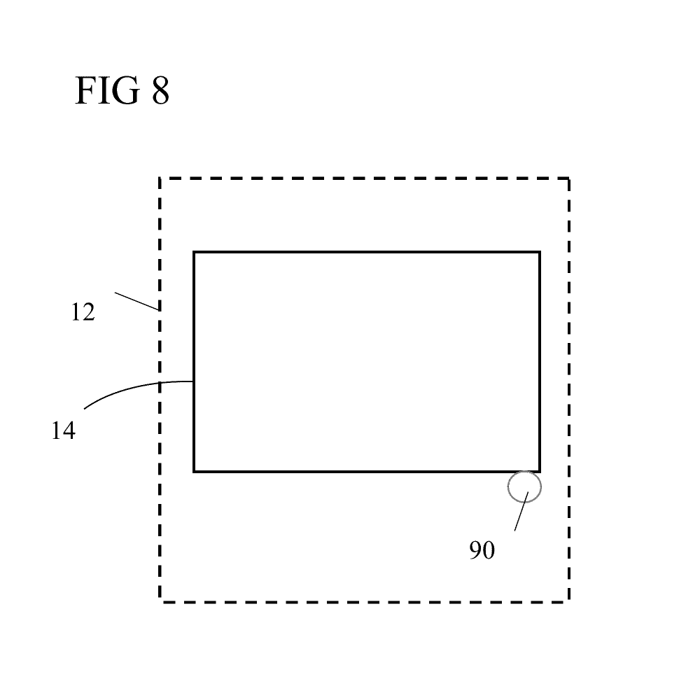

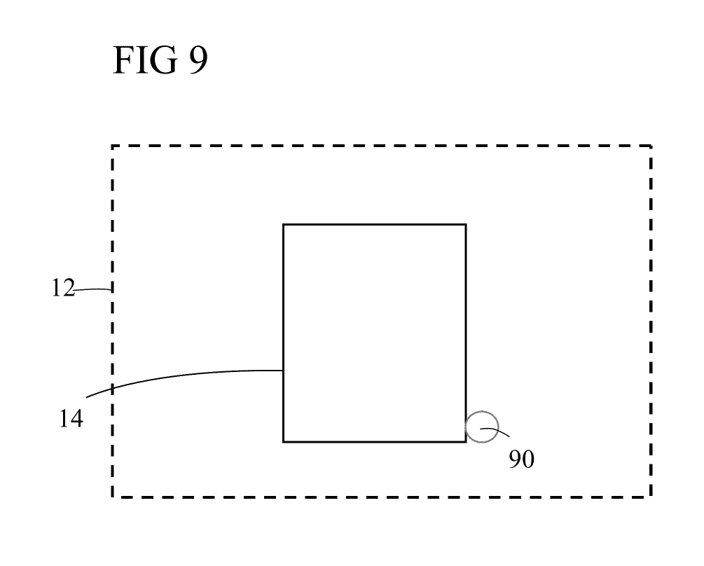

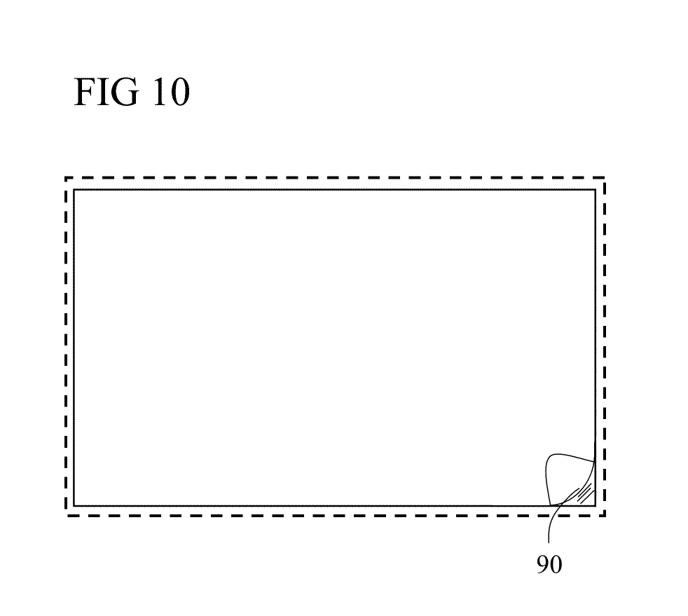

In another example, a gesture to flip page is described in FIG. 8 to FIG. 10. In FIG. 8 to FIG. 10 there are tae areas 90 in the lower right corner. A finger presses on the tab area 90 and hold for a time, the tab is attached to the finger. Finger could flip the page to see more information related to that page. At this time, the tab is in the left side (either upper left or lower left). Such technique could apply to webpage browsing as indicated in the above.

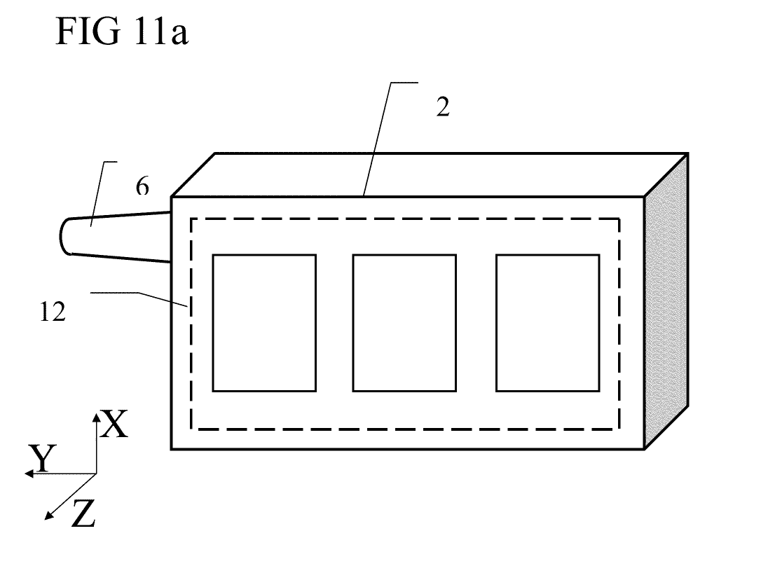

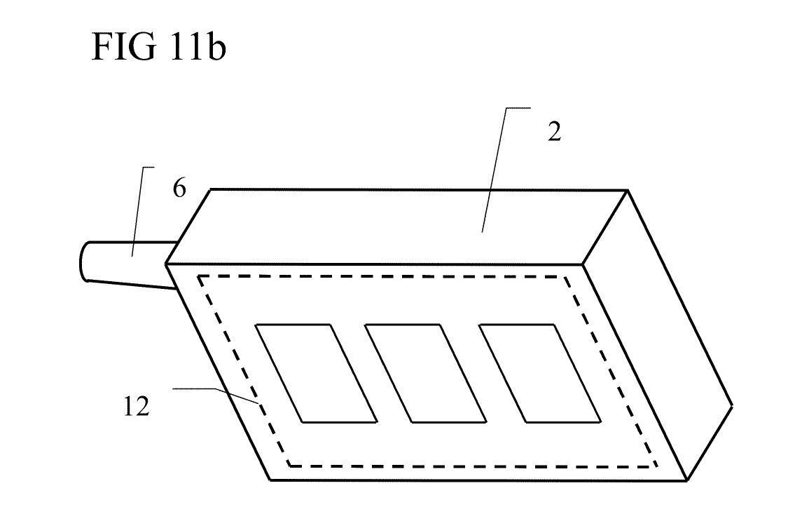

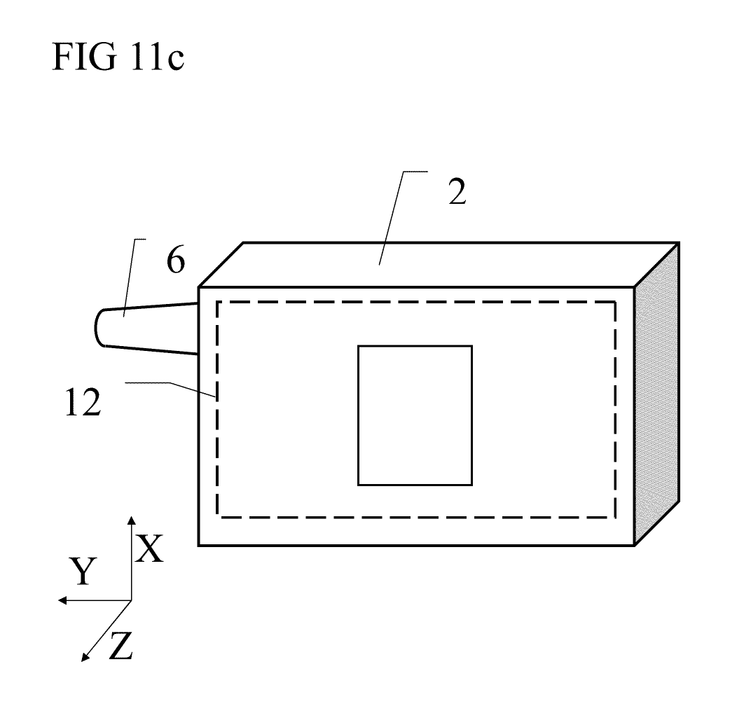

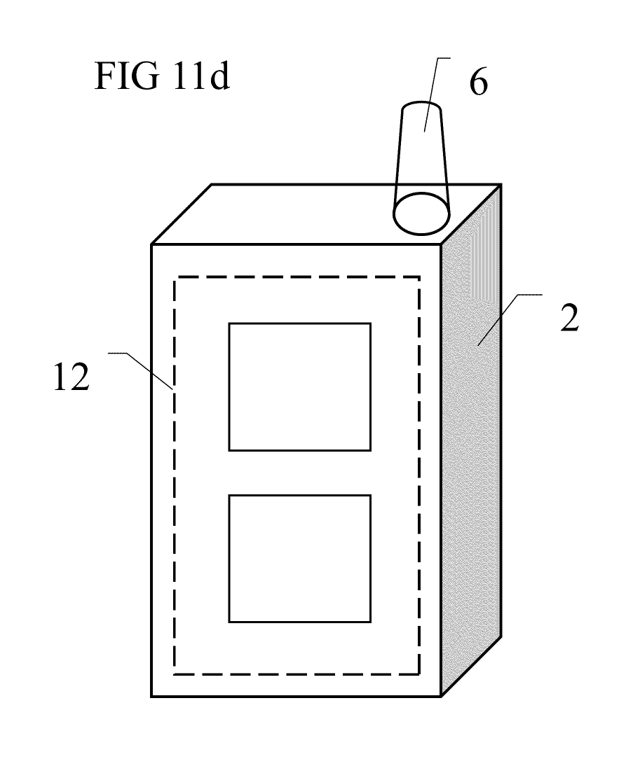

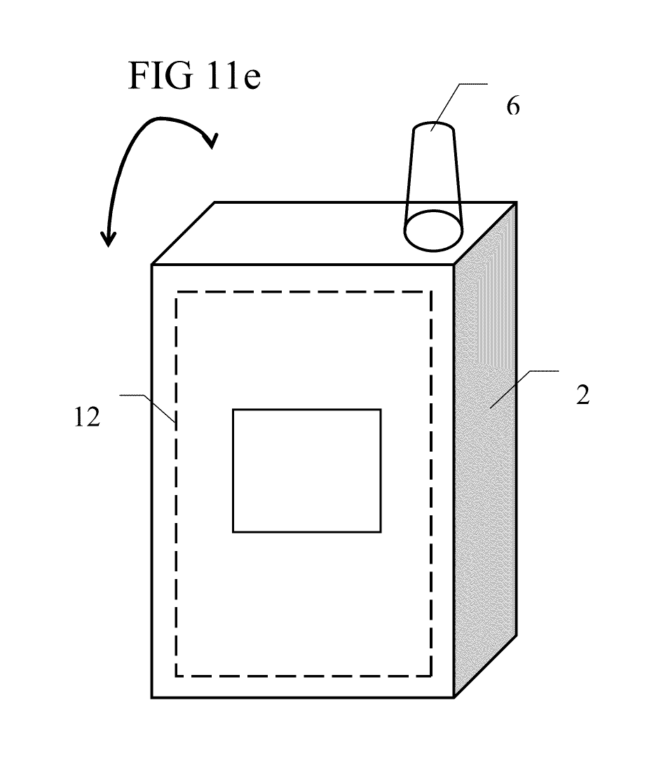

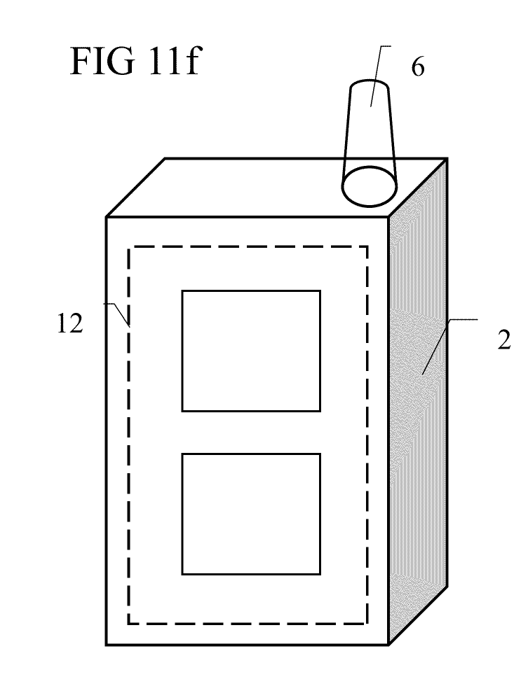

By application of a cube structure, the rotation of the cube in a smartphone with a built-in accelerometers to enter different modes is described in FIG. 11a. In FIG. 11a, a smartphone with the visible area 12 laid in the Y axis. In FIG. 11a, the phone is in the horizontal reviewing mode. By rotating the phone 2 from the direction of X to the direction of Z axis as illustrated in FIG. 11b, it rotates the cube as in FIG. 4a. After competition the action (first forward then backward to original position), FIG. 11c shows that it goes to the first vertical reviewing mode. When the phone 2 is situated in the position of 11c, a further rotation from Y axis to X axis to make the phone 2 stand up as shown in FIG. 11d does not change the mode (still in the first vertical reviewing mode). While from FIG. 11d, a normal horizontal swipe on the touch screen will change mode back to horizontal reviewing mode. FIG. 11e show the mode is changed to horizontal reviewing mode. From FIG. 11e, we applied same rotation as in FIG. 11b, the mode is changed to the first vertical reviewing mode as illustrated in FIG. 11f. Apply similar rotation logic, a proper physical rotation could change the mode from a vertical reviewing mode to the horizontal reviewing mode.

FIG. 12 describes the structure of modes. In FIG. 12, the first vertical reviewing mode shows a first photo of folders 42, that is photo 102. The photo 102 is belonged to folder 42 which is in the middle of the pull out menu 46. The pull out menu 46 shows folder 41, folder 42 and folder 43 as a portion of the folders of the queue 111. In the lower portion, the second vertical reviewing mode shows a first photo 202 of folder 114. The pull down menu 48 could show a portion of the folders or an action tab 110 in the queue 146. In the horizontal reviewing mode, the original photo 14 is in the same column with the associated page 158. No matter from photo 14 or photo 199, a rotation without moving folders in the pull out menu 46 or the pull out menu 48, it will show either photo 102 or photo 202. However, in one embodiment, the center folder of the pull out menu 46 or the pull out menu 48 will be automatically selected to fitting the current page or photo 14 or even to a queue of the horizontal reviewing mode.

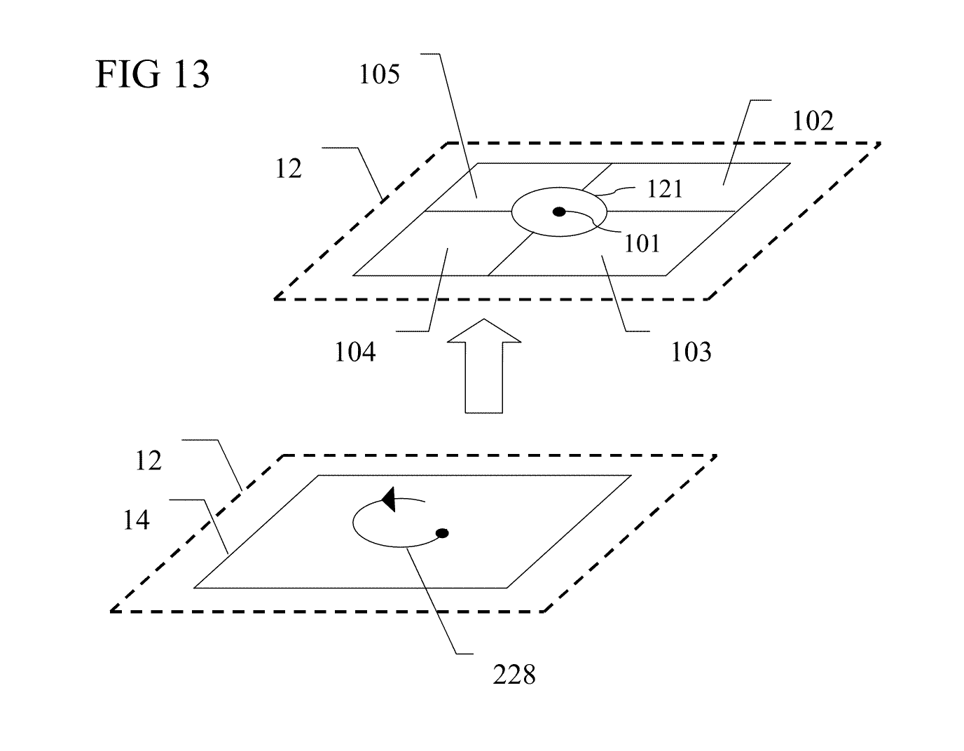

In one embodiment, an up gesture for example a circle gesture either counterclockwise or clockwise in the center of photo or page in either vertical reviewing mode or in the horizontal reviewing mode will lead to one of tree structure categories as shown in FIG. 13. While in either reviewing modes, a circle gesture 228 is detected, it enters the tree structure category with four photo folders as Pets photo 102, landscape photo 103, nature photo 104 and Paintings photos 105. The photo 14 is belonged to Pets photo 102. The category has a center area 101. Around the center area 101 is the circle area 121. The circle area 121 is used to help user applied a circle gesture to go to upper category in the tree structure categories. On example of upper layer category contains photo folder, video folder, music folder and document folder. The center area 101 is pressed to show two buffers areas as a temporary space for folders. For example, user could move one folder in the category to the buffer. The location of two buffers areas could be either left and right side of the category or upper and lower side. Pressing any folder of the category will enter that folder. However pressing a last folder will enter the horizontal reviewing mode. In one embodiment, moving a folder in a category need to press the center area 101 first, then drag the folder into a buffer. Each folder in the pull out menu 46 or 48 has corresponded position in the category. For example, if user applies the circle gesture in any photo of the first vertical reviewing mode and such photo belonged to printing folder 42, then it will go back to the category contains printing, my favorite, social network 1 and social network 2. At this time, user presses my favorite folder of that category, it goes to the horizontal reviewing mode. Then user could review my favorite photos and begin to make subfolders such as my favorite for Parents or my favorite for kids—a subfolder to my favorite folder). It should be noted that the circle gesture does not need to draw a perfect circle nor a close loop, therefore a portion of circle track is enough. Moreover to facilitate such circle gesture detection, circle track checking dots may show up to help user to draw such circle. In one embodiment, while in the time domain mode, an up gesture leads to the category contains time folders such as folders for dates, months or years.

Accordingly, it is to be understood that the embodiments of the invention herein described are merely illustrative of the application of the principles of the invention. For example in this disclosure, the files in folders that are manipulated include but not limited to photo files, multimedia files, HTML or XML files and other file format that is human-readable. Reference herein to details of the illustrated embodiments is not intended to limit the scope of the claims, which themselves recite those feature regarded as essential to the invention.

What is claimed is:

1. A computer implemented method, comprising: at a portable device with a touch screen,
(a) displaying one of first files in said touch screen;
(b) receiving a swipe gesture left or right from a user to browse each of first files in said touch screen in a horizontal reviewing mode;
(c) receiving a rotation gesture from the user to initiate a rotation transition;
(d) displaying a three dimensional cube rotation scene including a portion of one of second files during the transition in said touch screen; after the transition, displaying said one of second files in said touch screen;
(e) receiving a swipe gesture up or down from the user to browse each of second files in said touch screen in a vertical reviewing mode, and;
(f) receiving said swipe gesture left or right from the user in the vertical reviewing mode to return to the said horizontal reviewing mode, wherein said rotation gesture is a gesture other than said swipe gesture left or right.

2. The method of claim 1, wherein said rotation gesture comprising steps of touching an edge of a visible area of the touch screen and continuously moving said touching down to a certain depth and while applying said rotation gesture, a pull out menu is gradually shown up during said transition and said pull out menu contains plurality of folders, one of them is a blank folder that is provided for creating a new folder.

3. The method of claim 1, wherein said rotation gesture is said swipe gesture up or right, and while applying said rotation gesture, a pull out menu is gradually shown up during said transition and said pull out menu contains plurality of folders, one of them is a blank folder that is provided for creating a new folder.

4. The method of claim 3, further comprising a bounce back during said rotation transition.

5. The method of claim 3, wherein said plurality folders arranged in horizontal order in said pull out menu and further comprising applying said swipe left or right gesture to browse said plurality folders in said pull out menu.

6. The method of claim 5, further comprising while browsing, moving a chosen folder into the center of said pull out menu and displaying a portion of a file of said chosen folder, wherein files in the chosen folder become said second files.

7. The method of claim 1, wherein said files including photo files, multimedia files, webpages files, HTML files, XML files and other file type could be viewed and understandable by the user and further comprising an exploring gesture to read more content or associated information.

8. A computer implemented method, comprising: at a portable device with a touch screen,
a. displaying one of first files in said touch screen;
b. receiving a swipe gesture left or right from a user to browse each of first files in said touch screen in a horizontal reviewing mode;
c. receiving a first rotation gesture to initiate a rotation transition in an end of a first group in said horizontal reviewing mode;
d. displaying a three dimensional cube rotation scene including a portion of one of second files of a second group during the transition in said touch screen; after the transition, displaying said one of second files in said touch screen;
e. receiving a swipe gesture left or right from the user to browse each of second files in said touch screen;
f. receiving a rotation gesture to initiate a rotation transition to enter a vertical reviewing mode in one of first files or second files, and;
g. receiving said swipe gesture left or right from the user in the vertical reviewing mode to return to the said horizontal reviewing mode, wherein said rotation gesture is a gesture other than said swipe gesture left or right.

9. A computer system, comprising: a touch display; one or more processors; memory;
and a program, wherein the program is stored in the memory and configured to be executed by the one or more processors, the program including instructions for performing an interface on the touch display to browse and to move files of a first folder in a horizontal reviewing mode, files of a second folder a first vertical reviewing mode and files of a third folder in a second vertical reviewing mode,
said interface detecting a first reviewing gesture with a first gesture direction to browse files in the horizontal reviewing mode and detecting a second reviewing gesture with a second gesture direction to browse files in the first vertical reviewing mode and the second vertical reviewing mode;
said interface detecting a first rotating gesture with a second gesture direction to switch from the horizontal reviewing mode to the first vertical reviewing mode, a second rotating gesture with a second gesture direction to switch from the horizontal reviewing mode to the second vertical reviewing mode, and a return gesture with a first gesture direction switch from the first vertical reviewing mode to the horizontal reviewing mode or from the second vertical reviewing mode to the horizontal reviewing mode, said interface detecting a move gesture with a second gesture direction to move files from the horizontal reviewing mode to the first vertical reviewing mode or from the horizontal reviewing mode to the second vertical reviewing mode, and;
said program displaying a three dimensional cube rotation scene to show a portion of one of files of a second folder during the switching from the horizontal reviewing mode to the first vertical reviewing mode.

10. The computer system of claim 9, further comprising a folder selection mode which enables a user to select a folder to be browsed in the first vertical reviewing mode.

11. The computer system of claim 10, wherein said folder selection mode is entered during the switching from the horizontal reviewing mode to the first vertical reviewing mode.

12. The computer system of claim 9, further comprising a category reviewing mode which enables a user to review folders in each category, wherein each category is presented in different layers of a category tree.

13. The computer system of claim 12, wherein said category reviewing mode is entered by detecting an up gesture from the horizontal reviewing mode, the first vertical reviewing mode and the second vertical reviewing mode

14. The computer system of claim 12, further comprising in the category reviewing mode, the interface detecting an up gesture to enter said different layers of a category tree.

15. The computer system of claim 12, further comprising in the category reviewing mode, the program generating a center detection area of the touch screen to accept an input to generate a folder storage buffer in the side of the touch screen.
